(19) United States
(12) Patent Application Publication
(10) Pub. No.: US 2026/0210310 A1
(43) Pub. Date: Jul. 23, 2026

(54) THRUST REVERSER CASCADE FOR AN AIRCRAFT ENGINE

(71) Applicants: SAFRAN NACELLES, Gonfreville-l’Orcher (FR); CLAYENS NP, Genas (FR)

(72) Inventors: Fabrizio PAGANO, Moissy-Cramayel (FR); Bertrand Léon Marie DESJOYEAUX, Moissy-Cramayel (FR); Michel ROGNANT, Moissy-Cramayel (FR); Mohcine HASSAR, Genas (FR); Xavier BONJEAN, Genas (FR)

(73) Assignees: SAFRAN NACELLES, Gonfreville-l’Orcher (FR); CLAYENS NP, Genas (FR)

(21) Appl. No.: 19/142,389

(22) PCT Filed: Dec. 28, 2023
(86) PCT No.: PCT/FR2023/052135

§ 371 Date: Jun. 23, 2025

(30) Foreign Application Priority Data
Dec. 29, 2022 (FR) 2214651

(51) Int. Cl. F02K 1/72; B29C 45/26

(52) U.S. Cl. CPC F02K 1/72; B29C 45/2624

(57) ABSTRACT

Thrust reverser cascade including: spars each extending along a longitudinal direction and a direction, called height, and spaced from each other along a transverse direction, each spar including two large opposite faces, blade assemblies each extending transversely between two spars facing each other and spaced from each other along the longitudinal direction, each large face of each spar includes, between two consecutive blade assemblies, two sub-surfaces longitudinally offset and forming together, in a plane, an angle less than 90°, the two sub-surfaces being connected to each other by a third sub-surface which has, in a plane, a triangular shape with an apex in the low part of the spar and a base in the top part and which is longitudinally offset relative to the apex.

### TECHNICAL FIELD

The present disclosure relates to a thrust reverser cascade for an aircraft jet engine.

### PRIOR ART

A thrust reverser cascade for an aircraft jet engine generally comprises a plurality of spars each extending axially along a longitudinal direction X and the spars are disposed parallel to each other while being spaced from each other along a transverse direction Y. The cascade also comprises a plurality of blade assemblies extending between the spars along the transverse direction Y, spaced from each other along the longitudinal direction X. The blade assemblies define with the spars a plurality of cavities through which a thrust reversal air stream can flow to perform the thrust reversal function of the jet engine. Each blade assembly extends transversely along the transverse direction Y between two consecutive spars to which it is connected by two opposite respective connecting edges. Each blade assembly also extends along a direction Z perpendicular to the longitudinal X and transverse Y directions, from an edge called leading edge to an opposite edge called trailing edge, and at a curvature so as to form an aerodynamic profile of the blade assembly between the two edges.

Such a reverser cascade can be manufactured by injection molding by using shapes called “draft” shapes, which are easily demolded in one piece. Indeed, the molding of a multi-cavity cascade causes material shrinkage, and it is therefore necessary to have draft angles relative to the demolding directions in order to avoid any indentation, retention or cavity that would oppose the direct demolding of the piece.

In order to facilitate the demolding of such a multi-cavity reverser cascade, it is provided for the mold toolings to each include a positive draft angle, in particular to shape the facing faces of the spars between which fins are arranged transversely.

However, according to this design, the junction of the surfaces drafted relative to the direction of demolding forms, on each of the facing faces of the spars, a sharp step which appears in the form of a transverse indentation on the face. This indentation is oriented in an inclined manner starting from a longitudinal edge of the spar, near the leading edge of a blade assembly, in the direction of the opposite longitudinal edge of the spar, up to an area located near the extrados of the next blade assembly and at a distance from the opposite longitudinal edge.

The thus locally shaped spar faces affect the aerodynamic performance of the cascade when an air stream passing through it encounters these sharp steps by creating an aerodynamic drag phenomenon. Furthermore, these local shapings form a concentration of mechanical stresses that are likely to affect the structural strength of the cascade.

In view of the above, it would therefore be interesting to be able to manufacture a thrust reverser cascade for an aircraft jet engine by injection molding by improving the aerodynamic performance and the structural strength of the cascade.

### DISCLOSURE OF THE INVENTION

The invention thus relates to a thrust reverser cascade for an aircraft jet engine comprising:
a plurality of spars each extending along a longitudinal direction X and which are spaced from each other along a transverse direction Y, each spar also extending along a direction Z, called height, which is perpendicular to the longitudinal X and transverse Y directions, each spar including two large opposite faces,
a plurality of blade assemblies each extending between the spars along the transverse direction Y, the blade assemblies disposed between two spars facing each other being spaced from each other along the longitudinal direction X,
   each of the two large opposite faces of each spar including, between two consecutive blade assemblies spaced along the longitudinal direction X and each connected to the concerned large face of the spar, two sub-surfaces SS1, SS2 which are longitudinally offset relative to each other along the longitudinal axis X, the two sub-surfaces forming together, according to a projection view in a plane XY, a non-zero angle a less than 90°, the two sub-surfaces SS1, SS2 being connected to each other by a third sub-surface SS3 which has, according to a projection view in a plane XZ, a general triangular shape with an apex positioned in the low part of the spar and a base positioned in the top part of the spar and which is longitudinally offset relative to the position of the apex.

The third sub-surface of generally triangular shape in projection in a plane XZ allows gradually moving from the first sub-surface to the second sub-surface when considering a view in a plane XY with the second sub-surface which is inclined relative to the first sub-surface, instead of having a third sub-surface which extends transversely in an “abrupt” manner (step) as in the prior art. Such a shaping of the large opposite faces of the spars is obtained by means of two mold parts which are shaped in a suitable manner with adjacent surfaces which extend in an inclined manner along the longitudinal and transverse directions in order to result, on each of the large faces of the spars, in adjacent drafted surfaces which, joined together, form the third sub-surface of generally triangular shape in projection in a plane XZ of the concerned large face. Thus, the evolution in the thickness of the spar between two blade assemblies is gradual without a sharp step. This avoids the stress concentrations generated by abrupt thickness changes, and the air flowing between two blade assemblies along each of the two large opposite faces of a spar is less disrupted than before.

Depending on other possible characteristics, taken alone or in combination:
according to a projection view in a plane XY, the two sub-surfaces SS1, SS2 form together a non-zero angle less than 10°, preferably less than 5°;
each spar includes two opposite longitudinal edges which each connect the two opposite large faces of the spar to each other, the base of the general triangular shape of the third sub-surface SS3 of each large face of the spar being positioned, according to a projection view in a plane XZ, on the longitudinal edge, called upper edge, which is in the top part of the spar;
the apex of the general triangular shape is located, according to a projection view in a plane XZ, at a distance from the opposite longitudinal edge, called lower edge of the spar;
the general triangular shape of the third sub-surface SS3 of each large face of the spar comprises, according to a projection view in a plane XZ, one side of the triangle which is adjacent to the second sub-surface SS2 and which is inclined relative to the lower edge of the spar at an angle β which is comprised between 10 and 80°, preferably between 30 and 70°;
the general triangular shape of the third sub-surface SS3 of each large face of the spar comprises, according to a projection view in a plane XZ, another side of the triangle which is adjacent to the first sub-surface SS1 and which is inclined relative to the lower edge of the spar at an angle greater than the angle β and which is less than or equal to 90°;
the third sub-surface SS3 of each large face of each spar is planar, according to a projection view in a plane XY;
the third sub-surface of each large face of each spar is convex, according to a projection view in a plane XY;
the two consecutive blade assemblies spaced along the longitudinal direction X define together a cavity able to be crossed by an air stream, a first blade assembly including an extrados-forming surface oriented towards the cavity while the second blade assembly includes an intrados-forming surface oriented towards the cavity, a first SS1 of the two sub-surfaces SS1, SS2 of the concerned large face of the spar being adjacent to the first blade assembly while the second sub-surface SS2 is adjacent to the second blade assembly.

### BRIEF DESCRIPTION OF THE DRAWINGS

Other characteristics and advantages of the object of the present disclosure will emerge from the following description of embodiments, given as non-limiting examples, with reference to the appended figures.

FIG. 1 is a general schematic view of a thrust reverser cascade for a jet engine according to one embodiment of the invention;

FIG. 2 is an enlarged schematic view of one part of the cascade of FIG. 1;

FIG. 3 is a schematic view in projection in a plane XZ of the cascade part of FIG. 2;

FIG. 4 is a partial schematic top view, in projection in a plane XY, of the cascade part of FIG. 2;

FIG. 5 is a schematic view similar to that of FIG. 2 of a cascade part according to the prior art;

FIG. 6 is a general schematic top view showing one possible exemplary embodiment of one part of a mold for manufacturing the cascade of FIG. 1;

FIG. 7 is an enlarged general schematic partial view of the two parts nested together of a mold for manufacturing the cascade of FIG. 1 (closed mold);

FIG. 8 is a general schematic partial view along the section VIII-VIII of FIG. 7.

### DETAILED DESCRIPTION

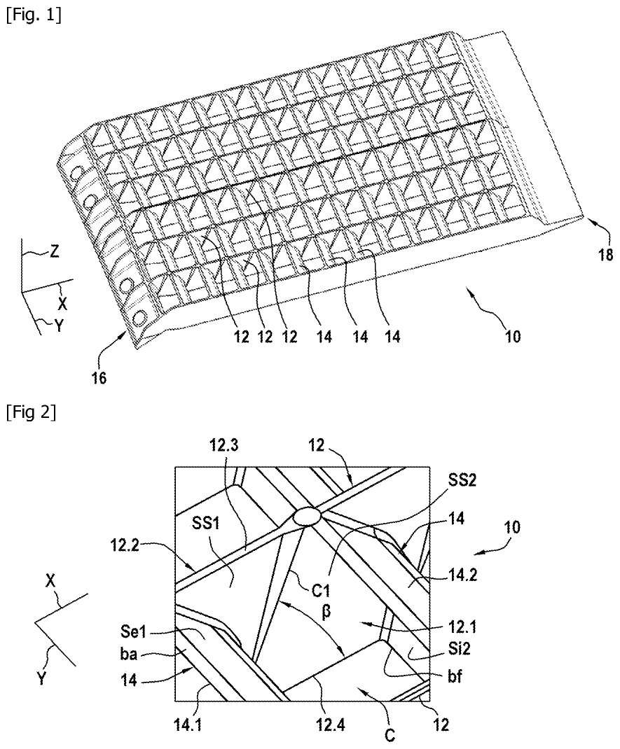

A thrust reverser cascade 10 for an aircraft jet engine, one possible embodiment of which is illustrated in FIG. 1, generally comprises, in perspective top view, a plurality of longitudinal (axial) spars 12 which each extend along a longitudinal direction X and which are spaced from each other along a transverse direction Y, as well as a plurality of blade assemblies 14 each extending transversely between the spars 12 along the transverse direction Y. The blade assemblies disposed between two spars facing each other are spaced from each other along the longitudinal direction X. The blade assemblies 14 intersect with the spars 12 to which they are connected so as to jointly form a cascade structure according to a view in a plane XY. Each spar 12 also extends along a third direction Z, called height, which is perpendicular to the longitudinal X and transverse Y directions. The cascade 10 thus also extends according to its height along the direction Z perpendicular to the first two directions X and Y. insofar as the blade assemblies are aerodynamic profiles, they also extend in the plane XZ. The cascade 10 also comprises a front flange 16 and a rear flange 18 respectively disposed at the two opposite ends of the cascade along the longitudinal direction X thereof. These flanges 16, 18 are used to fix the cascade to a nacelle of the aircraft jet engine.

FIG. 2 illustrates an enlarged partial perspective top view of the cascade of FIG. 1. In FIG. 2, two consecutive blade assemblies 14 spaced along the longitudinal direction X define together a cavity C which is able to be crossed by an air stream when the cascade is implemented to generate a counter-thrust stream. The two blade assemblies are each connected to the two parallel spars 12 opposite each other and the assembly formed by the blade assemblies and the spar portions located between the blade assemblies defines what can be called a unit cell of the cascade.

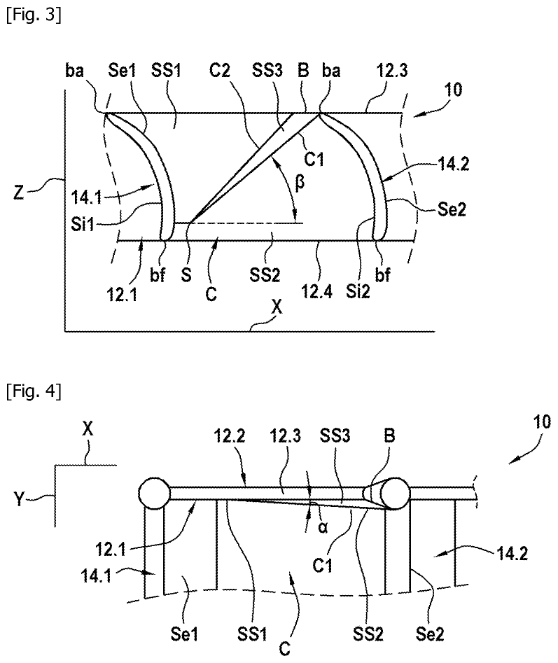

More particularly, the two consecutive blade assemblies 14 comprise a first blade assembly 14.1 including an extrados-forming surface Se1 oriented towards the cavity C, while the second blade assembly 14.2 includes an intrados-forming surface Si2 oriented towards the cavity. As represented in FIG. 3 which is a projection view in a plane XZ of the cell-forming assembly represented in FIG. 2, the two blade assemblies also include an intrados-forming surface Si1 for the blade assembly 14.1 and an extrados-forming surface Se2 for the blade assembly 14.2. Each blade assembly 14 also includes a leading edge ba and a trailing edge bf which are connected to each other by the aerodynamically profiled surfaces forming the intrados and extrados of each blade assembly. The position of the leading edges and of the trailing edges can alternatively be reversed.

Each spar 12 includes two large opposite faces 12.1 and 12.2, substantially parallel to each other and which each extend along the directions X and Z in projection in a plane XZ. One of the two large opposite faces, 12.1, is represented in the background of FIG. 3.

Each spar 12 also includes two opposite longitudinal edges 12.3 and 12.4 (small opposite faces of the spar) which each connect the two large opposite faces 12.1, 12.2 of the spar to each other in order to define the width or thickness of the spar along the transverse direction Y. One of the two edges is located in the top part of the spar and therefore of the cascade, when it is disposed as in FIG. 1 with its height aligned along the axis Z, and is called upper longitudinal edge 12.3, while the other opposite edge is located in the low part of the spar and therefore of the cascade, below the upper edge, and is called lower longitudinal edge 12.4 (FIG. 3).

Each of the two large opposite faces 12.1, 12.2 of each spar 12 includes, between two consecutive blade assemblies such as those 14.1, 14.2 of FIGS. 2 and 3 which are each connected to the concerned large face of the spar, two sub-surfaces SS1, SS2 which are longitudinally offset from each other along the longitudinal axis X.

As represented in FIGS. 2 and 3, a first, denoted SS1, of the two sub-surfaces SS1, SS2 is disposed adjacent to the first blade assembly 14.1 while the second sub-surface, denoted SS2, is adjacent to the second blade assembly 14.2.

FIG. 4 represents, in a top view of the cascade, in projection in a plane XY, part of the cell of FIGS. 2 and 3 and shows in particular that the two sub-surfaces SS1, SS 2 form together a non-zero angle a, less than 90°. This angle explains why each large spar face is not planar. In practice, the two sub-surfaces SS1, SS2 form together an angle a less than 10°, preferably less than 5°. This angle is used to demold the constituent pieces of the cascade during its manufacture by injection molding.

As represented in FIGS. 2 and 3, the two sub-surfaces SS1, SS2 are connected to each other by a third sub-surface SS3 which has, according to a projection view in a plane XZ (FIG. 3), a general triangular shape. This triangle is characterized by an apex S, a base B and two sides C1, C2 adjacent to the apex S. The apex S is positioned in the low part of the spar, near the lower longitudinal edge 12.4 but at a distance from it, while the base B is positioned in the low part of the spar, here on the upper longitudinal edge 12.3. The triangle is inclined in such a way that its base B is offset longitudinally in the direction of the second blade assembly 14.2 whose intrados faces the cavity C, relative to the position of the apex S which is offset longitudinally in the direction of the first blade assembly 14.1 whose extrados faces the cavity.

According to a projection view in a plane XZ (FIG. 3), the side C1 of the triangle which is adjacent to the second sub-surface SS2 is inclined relative to the lower edge 12.4 of the spar at an angle β which is comprised between 10 and 80°, preferably between 30 and 70°. It will also be noted that the opposite side C2 of the triangle which is adjacent to the first sub-surface SS1 is inclined relative to the lower edge 12.4 of the spar at an angle which is greater than the angle β and less than or equal to 90°. The area of extension of the third sub-surface SS3 can thus be more or less extended depending on the circumstances and needs.

As described above and illustrated in the figures, the third sub-surface SS3 defines in some way a transition sub-surface between the two sub-surfaces SS1, SS2 which ensures a gradual (“gentle”) increase in the inclination of the large face 12.1 of the spar to move from the sub-surface SS1 to the inclination of the sub-surface SS2.

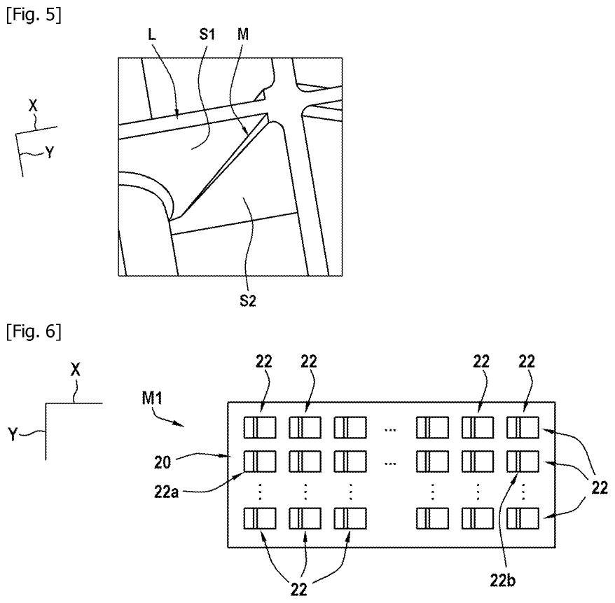

The prior art schematically represented in FIG. 5 for comparison purposes (view similar to that of FIG. 2) illustrates, between the two sub-surfaces S1 and S2 of the large face of the spar L, a third sub-surface which forms a step M extending transversely relative to the spars. This step is obtained on the large face of the spar as a result of the manufacturing constraints of the cascade by injection molding which impose the presence of a draft angle for the demolding of the parts of the mold. Such a configuration results in a large spar face that has an uneven (non-smooth) surface, causing disruptions, and therefore pressure losses, in the air flow passing through the cavity and along the large face.

In contrast, the embodiment described above has a configuration in which the third sub-surface SS3 is smooth or, in any case, does not include a major relief accident such as the step in FIG. 5. The third inclined sub-surface SS3 (FIG. 4) is planar in this exemplary embodiment but can alternatively be convex.

The thrust reverser cascade described above can be manufactured by injection molding by using at least two manufacturing molds M1 and M2.

FIG. 6 very schematically represents in a top view a part of the mold M1 which comprises a base or support surface 20 from which extend, away from the surface (direction of extension Z of the projections), a plurality of projections 22 spaced from each other so as to form a matrix according to a projection view in a plane XY.

The mold M2 comprises, for its part, a similar configuration with also a support/surface from which extend, away from the surface, a plurality of projections which are also spaced from each other so as to form a matrix similar to that of FIG. 6.

The shapes and positions in a plane XY of the projections 18 of the mold M1 and projections of the mold M2 are different from each other and complementary.

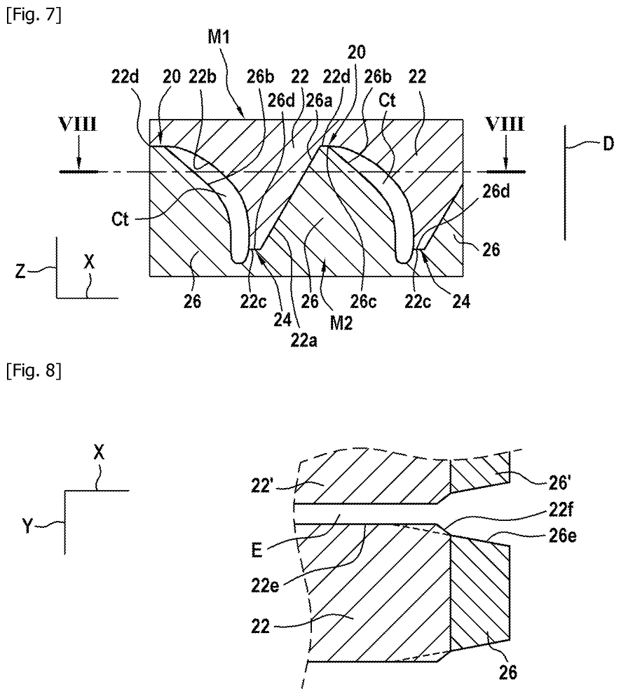

As represented in FIG. 7, the two mold parts M1 and M2 are positioned head to tail relative to each other, the part M1 of FIG. 6 having been turned over and positioned above the part M2 with the respective base/support surfaces 20 and 24 which are generally oriented horizontally (that is to say the plane XY of FIG. 2 is arranged horizontally) and brought together along the vertical axis Z so that the projections 22 of the mold part M1 are inserted or interposed between the projections 26 of the other mold part M2 and the two mold parts locally abut against each other to close the mold.

As represented in FIG. 7, the projections 22 each include, according to a view projected in a plane XZ, two inclined walls 22a, 22b in the direction of the flattened apex 22c of the projection 22 that they join and which forms a planar bearing. One 22a of the walls is rectilinear while the other 22b is concave. The two walls extend respectively from two planar portions 22d which each form a bearing of the base/support surface 20 on either side of each projection 22. Each of the two inclined faces 22a, 22b has open surfaces with respect to the demolding axis or direction D, that is to say these surfaces do not include local tangent planes in undercut relative to the direction D. The inclined face 22a generally has an opening angle of at least 1 to 2°. The demolding axis or direction is the axis or direction along which the two parts of the mold are separated from each other to demold the piece that has been manufactured by molding inside the mold.

The projections 26 of the mold M2 each include, according to a view projected in a plane XZ (FIG. 7), two inclined walls 26a, 26b in the direction of the flattened apex 26c of the projection 26 that they join and which forms a planar bearing. One 26a of the walls is rectilinear while the other 26b is convex. The wall 26a extends from a planar portion 26d which forms a bearing of the base/support surface 24, while the wall 26b extends from a downward indentation formed from the bearing 26d and which is intended to form the leading edge of the blade assembly. Each of the two inclined faces 26a, 26b has open surfaces with respect to the axis or direction of demolding D, that is to say these surfaces do not include local tangent planes in undercut relative to the direction D. The inclined face 26 a generally has an opening angle of at least 1 to 2°.

The curvatures of the two curved walls 22b and 26b are different from each other such that, in the final close position of FIG. 7 (closed mold), the two walls are longitudinally distant from each other and define together a transverse cavity Ct in which a transverse blade assembly of the cascade will be formed after injection of an injection material into the mold through conduits not represented here, and filling of the different cavities, in particular of the transverse cavity Ct. The two walls 22b and 26b facing each other for each pair of walls 22b and 26b define respectively the extrados and the intrados of the future blade assembly and their respective curvatures jointly define (in the plane XZ) the curvature of the aerodynamic profile of the blade assembly which can be more or less pronounced depending on the selected cascade configurations.

Furthermore, in the closed mold position of FIG. 7, the base/support surfaces 20, 24 with the respective support bearings 22d, 22c, 26c, 26d are in contact with each other and thus form a joint plane. It will be more particularly noted that the two inclined rectilinear walls 22a and 26a (identical inclination) of the two adjacent projections 22 and 26 are disposed against each other and define the closing slope of the mold. Similarly, the respective opposite bearings 22d and 26c, 22c and 26d are also disposed against each other and define two respective closing support surfaces of the mold. In the example represented, these surfaces are planar, but they can alternatively adopt a different shape. The sum of the dimensions along the axis X of the bearing 22d, of the face 22a, of the bearing 22c and of the face 22b determine what is called longitudinal “pitch” (along X) between two blade assemblies. The inclination of the closing slope (inclined faces 22a, 26a) directly influences the pitch between the blade assemblies, as does the dimension along the direction X (length) of the closing support surfaces.

FIG. 8 schematically illustrates in section along the cutting plane VIII-VIII of FIG. 7 the two adjacent projections 22, 26 of FIG. 7 which are disposed in contact against each other by their respective inclined faces 22a and 26a. This figure also represents another pair of projections 22′, 26′in contact with each other. The two pairs of projections are transversely (along Y) spaced apart from each other and thus define together a space E in which a future spar will be formed. This space E also extends along the axis X to define the length of the spar and the perpendicular axis Z in order to define the height of the spar. The part of the space E represented in FIG. 8 corresponds to the part of the spar which is located between two consecutive blade assemblies and which is visible in FIGS. 2 to 4.

FIG. 8 more particularly illustrates the general shape of the two projections 22 and 26 in top view and shows, in the cutting plane VIII-VIII, that the projection 22 includes, in the plane XY, on one of its two opposite sides, a rectilinear face 22e and a beveled face 22f. This beveled face 22f extends along the direction X, as illustrated by the dotted lines, and also along the direction Z (although this is not represented in FIG. 8) in order to define the surface of the third sub-surface SS3 which is a surface inclined both relative to a plane XZ and relative to a plane XY (FIGS. 1 to 3). The inclination of the beveled face relative to the longitudinal direction X is the same as that of the base B of the triangle in FIG. 4. The projection has the same configuration on its opposite side (at the bottom in FIG. 8).

The projection 26 has, for its part, a substantially trapezoidal profile with the lateral faces 26e inclined so as to define the second sub-surface SS2 inclined along a plane XY relative to the first sub-surface SS1. The lateral faces 26e are also inclined in a plane YZ although this is not represented in FIG. 8.

The mold configuration just described thus allows defining the configuration of the surface of the large face 12.1 of the spar which is disposed between the two consecutive blade assemblies 14.1 and 14.2 of FIGS. 2 to 4.

The manufacture of the thrust reverser cascade by injection molding by using the mold described above requires, in particular, the introduction of an injection material of known type, for example a thermoplastic or short fiber-reinforced thermoplastic material inside the mold, so that it is distributed in the various longitudinal and transverse cavities which are jointly defined between the two mold parts. After solidification of the material, the cascade is demolded by removing the molded piece from one and the other mold part along the demolding axis or direction D indicated above.

Although the present description refers to specific exemplary embodiments, modifications may be made to these examples without departing from the general scope of the invention as defined by the claims. Furthermore, individual characteristics of the various embodiments illustrated or mentioned may be combined in additional embodiments. Consequently, the description and the drawings should be considered in an illustrative rather than restrictive sense.

1. A thrust reverser cascade for an aircraft jet engine, comprising:
a plurality of spars each extending along a longitudinal direction and which are spaced from each other along a transverse direction, each spar also extending along a direction, called height, which is perpendicular to the longitudinal and transverse directions, each spar including two large opposite faces,
a plurality of blade assemblies each extending between the spars along the transverse direction, the blade assemblies disposed between two spars facing each other being spaced from each other along the longitudinal direction,
each of the two large opposite faces of each spar including, between two consecutive blade assemblies spaced along the longitudinal direction and each connected to the concerned large face of the spar, two sub-surfaces which are longitudinally offset relative to each other along the longitudinal axis, the two sub-surfaces forming together, according to a projection view in a plane, a non-zero angle a less than 90°, the two sub-surfaces being connected to each other by a third sub-surface which has, according to a projection view in a plane, a general triangular shape with an apex positioned in the low part of the spar and a base positioned in the top part of the spar and which is longitudinally offset relative to the position of the apex.

2. The thrust reverser cascade according to claim 1, wherein, according to a projection view in a plane the two sub-surfaces form together a non-zero angle less than 10°, preferably less than 5°.

3. The thrust reverser cascade according to claim 1, wherein each spar includes two opposite longitudinal edges which each connect the two opposite large faces of the spar to each other, the base of the general triangular shape of the third sub-surface of each large face of the spar being positioned, according to a projection view in a plane, on the longitudinal edge, called upper edge which is in the top part of the spar.

4. The thrust reverser cascade according to claim 3, wherein the apex of the general triangular shape is located, according to a projection view in a plane, at a distance from the opposite longitudinal edge, called lower edge of the spar.

5. The thrust reverser cascade according to claim 4, wherein the general triangular shape of the third sub-surface of each large face of the spar comprises, according to a projection view in a plane, a side of the triangle which is adjacent to the second sub-surface and which is inclined relative to the lower edge of the spar at an angle β which is comprised between 10 and 80°, preferably between 30 and 70°.

6. The thrust reverser cascade according to claim 5, wherein the general triangular shape of the third sub-surface of each large face of the spar comprises, according to a projection view in a plane, another side of the triangle which is adjacent to the first sub-surface and which is inclined relative to the lower edge of the spar at an angle greater than the angle β and which is less than or equal to 90°.

7. The thrust reverser cascade according to claim 1, wherein the third sub-surface of each large face of each spar is planar, according to a projection view in a plane.

8. The thrust reverser cascade according to claim 1, wherein the third sub-surface of each large face of each spar is convex, according to a projection view in a plane.

9. The thrust reverser cascade according to claim 1, wherein the two consecutive blade assemblies-spaced along the longitudinal direction define together a cavity able to be crossed by an air stream, a first blade assembly including an extrados-forming surface oriented towards the cavity, while the second blade assembly includes an intrados-forming surface oriented towards the cavity, a first of the two sub-surfaces of the concerned large face of the spar being adjacent to the first blade assembly, while the second sub-surface is adjacent to the second blade assembly.
